(19) United States
(12) Patent Application Publication
(10) Pub. No.: US 2014/0089192 A1
(43) Pub. Date: Mar. 27, 2014

(54) SECOND LEVEL PROCESSING SYSTEM AND METHOD

(71) Applicants: Benjamin Scott Boding, Mt. View, CA (US); Andrew Naumann zu Koenigsbrueck, Vashon, WA (US); Cory H. Siddens, Mt. View, CA (US)

(72) Inventors: Benjamin Scott Boding, Mt. View, CA (US); Andrew Naumann zu Koenigsbrueck, Vashon, WA (US); Cory H. Siddens, Mt. View, CA (US)

(21) Appl. No.: 13/926,785

(22) Filed: Jun. 25, 2013

Related U.S. Application Data
(60) Provisional application No. 61/664,088, filed on Jun. 25, 2012.
(60) Provisional application No. 61/673,182, filed on Jul. 18, 2012.

(51) Int. Cl. G06Q 20/38

(52) U.S. Cl. CPC G06Q 20/382
USPC 705/44

(57) ABSTRACT

Embodiments of the invention are directed to computer that can utilize a first computer and a second computer. The first computer may determine a first fraud score based on transaction data. If the first fraud score is indeterminate, the transaction may be assigned to a transaction review queue. If the subsequent review takes too long to complete, then a second computer may be used to compute a second fraud score to determine an outcome for the transaction.

### CROSS-REFERENCES TO RELATED APPLICATIONS

The present application is a non-provisional application of and claims priority to U.S. Provisional Application Nos. 61/664,088, filed on Jun. 25, 2012 (Attorney Docket No.: 79900-839896), and 61/673,182, filed on Jul. 18, 2012 (Attorney Docket No.: 79900-839904), the entire contents of which are herein incorporated by reference for all purposes.

### BACKGROUND

Embodiments of the present invention relate to systems and methods for improving the efficiency and quality of transaction review systems and methods.

In e-commerce transactions, a merchant computer can analyze transaction data to determine if a transaction associated with that transaction data is fraudulent. The computer may produce a transaction fraud score, which may provide an initial assessment regarding whether the transaction is highly likely to be fraudulent or highly unlikely to be fraudulent. The transaction may be rejected if the transaction is highly likely to be fraudulent or may be accepted if the transaction is highly likely to be authentic. If the transaction fraud score is indeterminate (i.e., the transaction is neither clearly fraudulent nor clearly authentic), then the transaction may be sent to a queue for review by a human reviewer. In some cases, the human reviewer may have too many transactions to review and may have trouble reviewing transactions in a timely manner. If the transaction data is insufficient for the human reviewer to determine if the transaction is highly likely to be fraudulent or highly likely to be authentic, then the human reviewer may also have to manually contact a data provider such as LexisNexis™ to obtain more information to arrive at a decision as to whether to accept or reject the transaction. Consequently, in some cases where a transaction is considered indeterminate, the transaction decision process may take too long. This can be problematic since sales can be lost if decisions on transactions cannot be made quickly. While it may be possible to simply hire more human reviewers to account for the additional review of transactions, this can be expensive to implement and burdensome to manage.

Embodiments of the invention address these and other problems, individually and collectively.

### BRIEF SUMMARY

Embodiments of the present invention relate to systems and methods for improving the efficiency and quality of transaction review systems and methods.

One embodiment of the invention is a computer comprising a processor; and a computer readable medium coupled to the processor. The computer readable medium comprises code, executable by the processor, for implementing a method. The method comprises a) receiving, by a first computer, transaction data for a transaction, b) determining, by the first computer, a first transaction score for the transaction, c) determining, by the first computer, that the first transaction score is indeterminate, d) storing the transaction data in a review queue, e) providing, by the first computer, the transaction data to a second computer after a predetermined time has elapsed and the transaction data has not been reviewed, f) determining a second transaction score, and g) determining an outcome for the transaction using the second transaction score.

Another embodiment of the invention is directed to a method comprising a) receiving, by a first computer, transaction data for a transaction, b) determining, by the first computer, a first transaction score for the transaction, c) determining, by the first computer, that the first transaction score is indeterminate, d) storing the transaction data in a review queue, e) providing, by the first computer, the transaction data to a second computer after a predetermined time has elapsed and the transaction data has not been reviewed, f) determining a second transaction score; and g) determining an outcome for the transaction using the second transaction score.

These and other embodiments of the invention are described in further detail below.

### BRIEF DESCRIPTION OF THE DRAWINGS

FIG. 1 shows a block diagram of a system according to an embodiment of the invention.

FIG. 2 shows a block diagram of a merchant processor system according to an embodiment of the invention.

FIG. 3 shows a flow chart illustrating methods according to embodiments of the invention.

FIG. 4 shows a flow chart illustrating additional processing associated with determining a second fraud score.

FIG. 5 shows a user interface for a merchant to provide second level processing preference information.

FIG. 6 shows a block diagram of a computer apparatus.

### DETAILED DESCRIPTION

One embodiment of the invention is directed to a method. The method comprises receiving, by a first computer, transaction data for a transaction. The first computer determines a first transaction score for the transaction, and then determines if the first transaction score is indeterminate. A transaction may be indeterminate if it is not highly likely to be fraudulent or not highly likely to be authentic. If the transaction is indeterminate, then the transaction data is stored in a review queue. For example, on a scale of 1 to 10, with 1 being authentic and 10 being fraudulent, a score of 1-5 may be indicate that a transaction is highly likely to be authentic. A score of 9-10 may indicate that the transaction is highly likely to be fraudulent. A score of 6-8 may indicate that the transaction is indeterminate.

If a predetermined period of time has elapsed and the transaction data has not been reviewed by a human reviewer, the first computer provides the transaction data to a second computer. The second computer then queries at least one data source external to the first computer for supplemental data. The supplemental data may be additional data that provides further information that can be used to decide whether to accept or reject the transaction and that was not previously available to the first computer. Upon receipt of the supplemental data, the second computer determines a second transaction score based on the transaction data and the supplemental data. In some embodiments, the second computer may provide the second transaction score to the first computer, and the first computer may determine an outcome for the transaction based on the second transaction score. The outcome may alternatively be determined by the second computer. The outcome may be to accept or reject the transaction without further human intervention.

Prior to discussing specific embodiments of the invention, some terms may be discussed in further detail.

A “computer” may include any suitable number of apparatuses, which may operate to accomplish one or more predetermined preprogrammed functions. A computer has one or more data processors and data storage units (e.g., volatile or non-volatile memories).

A “server computer” may include a powerful computer or cluster of computers. For example, the server computer can be a large mainframe, a minicomputer cluster, or a group of servers functioning as a unit. In one example, the server computer may be a database server coupled to a Web server. The server computer may be coupled to a database and may include any hardware, software, other logic, or combination of the preceding for servicing the requests from one or more client computers. The server computer may comprise one or more computational apparatuses and may use any of a variety of computing structures, arrangements, and compilations for servicing the requests from one or more client computers.

A “client computer” may include one or more computational apparatuses. The client computer may be operated by a user such as a consumer. The client computer may use any suitable wired or wireless network, including the Internet, in order to communicate with other systems. Examples of client computers may include a desktop computer, a laptop, a wireless phone, a personal digital assistant (PDA), a smart watch, etc. A client computer may operate using any suitable operating system including a Windows™ based operating system.

A “data aggregator” may include one or more computers, which can collect data from a plurality of different data sources. In some embodiments, the data aggregator may receive data from the data sources and may normalize the data from the different data sources. For example, the data from the different data sources may be converted to a common format so that data from the different data sources can be used together to determine a fraud score. For example, two different data sources may provide address information of a user to a second computer for analysis. The address information from the two different data sources may be formatted differently (e.g., one uses the word “St.” while the other uses “Street”). The data aggregator could normalize the address information from the data sources so that it can be analyzed with address information in the transaction data (e.g., all data uses “St.”).

A “transaction score” may be a quantitative value associated with a transaction. In some embodiments, a transaction score may be a risk score such as a fraud risk score. A fraud risk score may be a value that indicates a likelihood of a transaction being potentially fraudulent. For example, a fraud risk score may be a value of 1 to 100. A fraud risk score of 100 indicates that the transaction is very likely to be fraudulent, while a fraud risk score of 1 indicates that the transaction is very unlikely to be fraudulent. In other embodiments, the transaction score could alternatively be a risk score that indicates a likelihood of whether or not the particular user that is conducting the transaction can pay for the transaction. The risk score may also be used to determine an outcome for a transaction (e.g., accept or reject the transaction).

A “database” may include any suitable structure for storing and facilitating the retrieval of information. Also, the database may use any of a variety of data structures, arrangements, and compilations to store and facilitate retrieval of information. The database may be a conventional, fault tolerant, relational, scalable, secure database such as Oracle™ or Sybase™.

A “review queue” may be a data structure resident in a data storage device that includes a list of records such that records are added at one end and removed from the other. In some embodiments of the invention, the review queue can order transaction data for transactions for human review on a first-in, first-out basis. In some embodiments, the review queue may be updated or modified to adjust the order of the records, based on one or more predetermined priorities. For example, if a subsequent transaction is time sensitive (e.g., the purchase of an airline ticket for a flight leaving in a few hours) and a prior transaction is not time sensitive (e.g., the purchase of a book), then the review queue may be updated so that the subsequent transaction will be reviewed prior to the prior transaction.

“Transaction data” may include initial data associated with a transaction. In embodiments of the invention, transaction data may include user information (e.g., a billing address and/or shipping address of the user), a purchase price, payment information (e.g., a credit card number, card verification value, expiration date, etc.), the identity of the merchant conducting the transaction, the goods or services purchased in the transaction, the IP (internet protocol) address of the client computer conducting the transaction, etc.

“Supplemental data” may include any suitable information that can help determine an outcome for a transaction that supplements the transaction data. In some embodiments of the invention, supplemental data is obtained after a transaction is initiated by a user and after a first transaction score is determined. Supplemental data may be similar to data elements in transaction data, or may be different. For example, supplemental data received from external may include data elements such as user shipping address, billing address, phone number, e-mail address, etc. Alternatively or additionally, supplemental data may include non-transaction data including credit scores, social network association information, home value, credit history, and other information. Another example of supplemental data may include data that is obtained after doing an additional out-of-band lookup that requires additional consumer validation, like responding to an SMS text message or e-mail. Another example of supplemental data may include data obtained from a deeper analysis that takes longer than the time allotted for a transaction, such as a complex historical transaction analysis. Another example of supplemental data may include data that results from performing a wider search of the Internet to gather reference information of a particular piece of data such as an email address that is being used on various social network sites.

A “data source” may include any suitable computer apparatus which can supply supplemental data for one or more transactions. Different data sources may store, format, and collect data in different ways, and may be run by organizations that run independently. Examples of data sources include an apparatus that stores legal and public-records related documents such as TARGUSinfo™, LexisNexis™ or Westlaw™, a social network host site such as Facebook™, a system that stores payment transaction data such as VisaNet™, etc., government databases (e.g., the DMV or department of motor vehicles in a state), credit reporting agencies (e.g., Experian™).

An “authorization request message” may be an electronic message that is sent to a payment processing network and/or an issuer of a payment card to request authorization for a transaction. An authorization request message according to some embodiments may comply with ISO 8583, which is a standard for systems that exchange electronic transaction information associated with a payment made by a consumer using a payment device or payment account. The authorization request message may include an issuer account identifier that may be associated with a payment device or payment account. An authorization request message may also comprise additional data elements corresponding to “identification information” including, by way of example only: a service code, a CVV (card verification value), a dCVV (dynamic card verification value), an expiration date, etc.

An “authorization response message” may be an electronic message reply to an authorization request message generated by an issuing financial institution or a payment processing network. The authorization response message may include, by way of example only, one or more of the following status indicators: Approval—transaction was approved; Decline—transaction was not approved; or Call Center—response pending more information, merchant must call the toll-free authorization phone number. The authorization response message may also include an authorization code. The code may serve as proof of authorization. As noted above, in some embodiments, a payment processing network may generate or forward the authorization response message to the merchant.

I. Systems

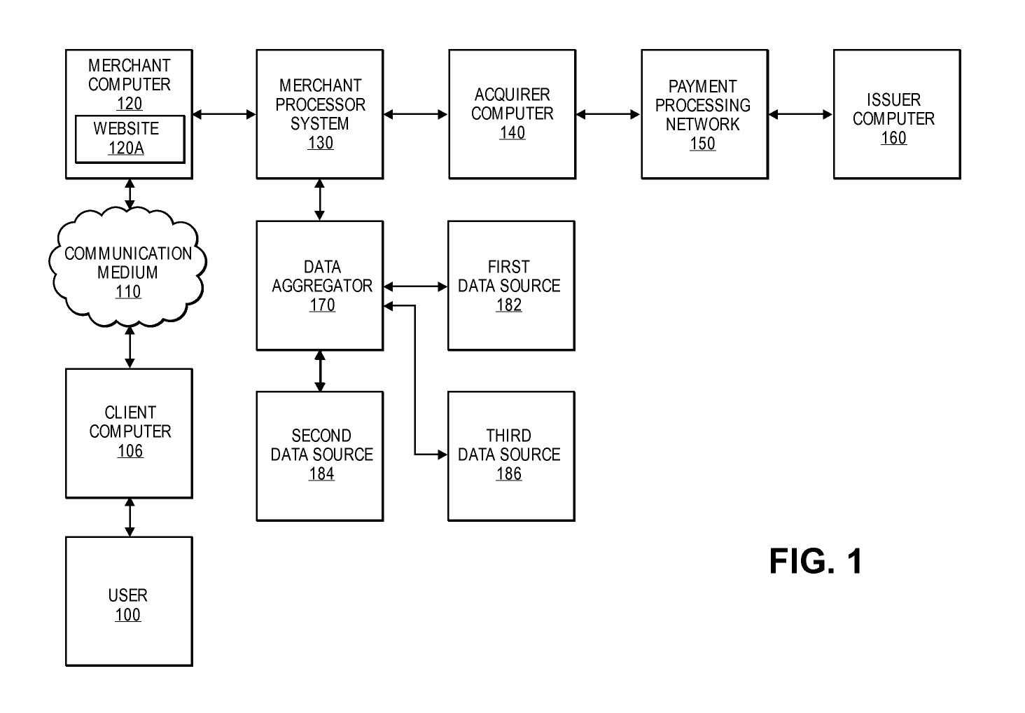

FIG. 1 shows a block diagram of a system according to an embodiment of the invention. The system comprises a user 100 that uses a client computer 106. The client computer 106 is coupled to a merchant computer 120 via a communication medium 110. The merchant computer 120 may be coupled to a merchant processor system 130, which is in turn coupled to an acquirer computer 140 and an issuer computer 160. A payment processing network 150 may also be coupled to the merchant processor system 130 and may reside between (in an operational sense) the acquirer computer 140 and the issuer computer 160.

The user 100 may be an individual, or an organization such as a business that is capable of purchasing goods, services, or conducting transactions. The user 100 may operate the client computer 106, which can be a computer, laptop, wireless phone, personal digital assistant (PDA), etc.

The communication medium 110 may comprise a communications network which may include a direct interconnection, the Internet, a Local Area Network (LAN), a Metropolitan Area Network (MAN), a secured custom connection, a Wide Area Network (WAN), a wireless network (e.g., employing protocols such as Wireless Application Protocol (WAP), I-mode, etc.).

The merchant computer 120 may run by a merchant, which may be an individual or an organization that engages in transactions and can sell goods or services. In an embodiment, the merchant 120 may also provide a website 120A which allows the user 100 to conduct a transaction with the merchant 120.

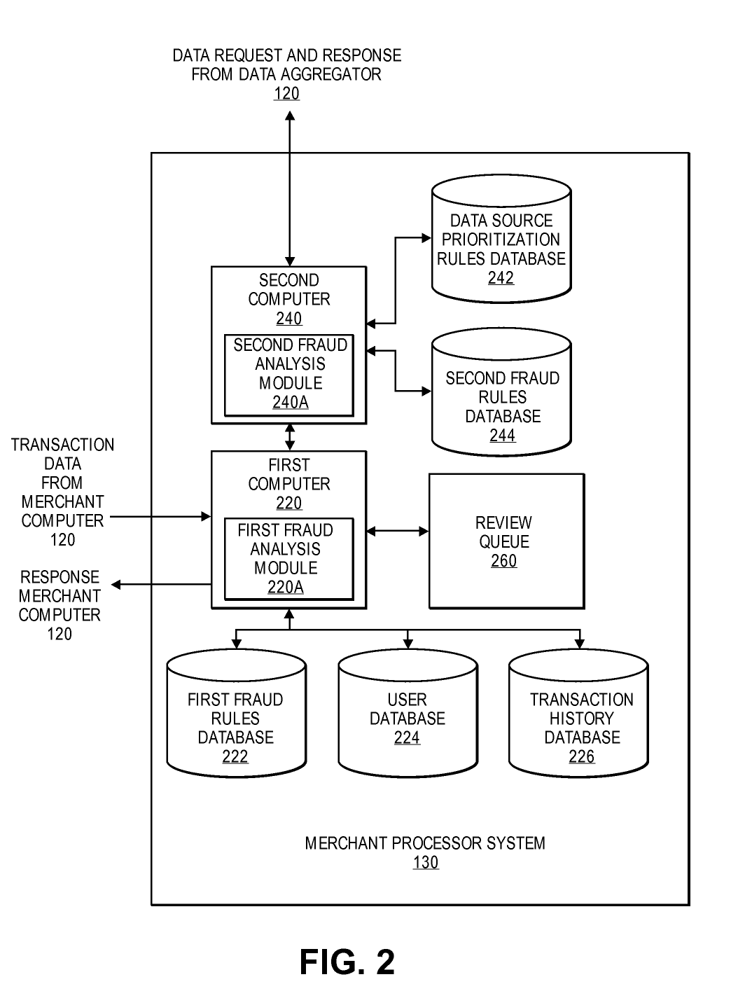

The merchant processor system 130 may process transactions on behalf of the merchant that operates the merchant computer 120. In some embodiments, the merchant processor system 130 may process transactions on behalf of many types of merchants. The merchant processor is described in detail below with respect to FIG. 2.

The merchant processor system 130 may also operate a fraud detection system. The fraud detection system can have the ability to receive, process and evaluate transaction data for a transaction to determine if the transaction is likely fraudulent or likely authentic. In some embodiments, the fraud detection system stores specific fraud detection rules for different merchants. Such fraud detection rules in the merchant processing system 130 may be customized by the different merchants.

Since each merchant is unique, different merchants may have different fraud profiles that can be created, modified, and/or deleted in the merchant processor system 130. A fraud profile may be a set of rules that is pre-defined by a merchant. After a fraud profile is applied to transaction data for a transaction, a score can be created. Fraud profiles are described in further detail in U.S. patent application Ser. No. 13/770,895, filed on Feb. 19, 2013, which is herein incorporated by reference in its entirety for all purposes.

After a fraud profile is applied to transaction data, the transaction can have one of the following statuses: accept, reject, review, and/or monitor. “Accept” means that a transaction is accepted. “Reject” means that the transaction is rejected. “Review” means that the transaction should be reviewed by a human reviewer. “Monitor” means that the transaction should be monitored until further notice.

In embodiments of the invention, the fraud detection system may also provide an audit log of the modifications made to the customizable settings to track changes that are made to a merchant's fraud profile. The fraud detection system may also create reports and statistical analyses for transactions conducted by the merchants.

The merchant processor system 130 may also be coupled to a number of data sources including a first data source 182, a second data source 184, and a third data source 186 via a data aggregator 170. The first data source 182, the second data source 184, and the third data source 186 may store different types of data in different formats. As noted above, different data sources may store, format, and collect data in different ways, and may be run by organizations that run independently. Examples of data sources include an apparatus that stores legal and public-records related documents such as LexisNexis™ or Westlaw™, a social network host site such as Facebook™. The cost, time to retrieve, and quality of the data from the various data sources may vary. Because of this, in some embodiments, the data aggregator 170 and/or a second computer in the merchant processor system 130 may apply predetermined rules provided by the merchants. The rules may take into account the cost, time to retrieve, and quality of the supplemental data that can be obtained from the various data sources for the particular transaction being reviewed. The data aggregator 170 can also normalize the data from the various data sources by converting, removing, or adding data from the various data sources so that the data can be used to determine a second transaction score. Although the data aggregator 170 is shown as being outside of the merchant processor system 130, it may be inside of the merchant processor system 130 in other embodiments.

The acquirer computer 140 may be a computer that is operated by an acquirer. An acquirer may typically refer to a business entity (e.g., a commercial bank or financial institution) that has a business relationship with a particular merchant or similar entity. Some entities can perform both issuer and acquirer functions.

The payment processing network 150 may be located between (in an operational sense) the acquirer computer 140 and an issuer computer 160. The payment processing network 150 may include data processing subsystems, networks, and operations used to support and deliver authorization services, exception file services, and clearing and settlement services. For example, the payment processing network 150 may comprise a server computer, coupled to a network interface (e.g. by an external communication interface), and a database(s) of information. An exemplary payment processing network may include VisaNet™. Payment processing networks such as VisaNet™ are able to process credit card transactions, debit card transactions, and other types of commercial transactions. VisaNet™, in particular, includes a VIP system (Visa Integrated Payments system) which processes authorization requests and a Base II system which performs clearing and settlement services. The payment processing network 150 may use any suitable wired or wireless network, including the Internet.

The issuer computer 160 may run by an issuer. An issuer is typically a business entity (e.g., a bank or other financial institution) that maintains financial accounts for the user 100 and often issues a payment device such as a credit or debit card to the user 100.

Although a specific number of components are shown in FIG. 1 for simplicity of illustration, embodiments of the invention are not limited thereto, and there can be many more components in other systems in other embodiments of the invention. For example, although one merchant computer, one client computer and one user are shown in FIG. 1, other embodiments of the invention may include more components.

FIG. 2 shows a block diagram of a merchant processor system 130 according to an embodiment of the invention.

Referring to FIG. 2, the merchant processor system 130 can comprise a first computer 220 comprising a first fraud analysis module 220A, and a second computer 240 comprising a second fraud analysis module 240A. In some embodiments, the first and second fraud analysis modules 220A, 240A may be software modules that are encoded on computer readable media (not shown in FIG. 2) associated with each of the first and second computers 220, 240. The computer readable may be coupled to data processors (not shown in FIG. 2) which may execute the modules to perform the functions described herein. The first computer 220 and the second computer 240 may be in communication with each other, as well as in communication with a review queue 260.

In some embodiments, the first computer 220 may be a computer that has a processor; and a computer readable medium coupled to the processor. The computer readable medium comprises code, executable by the processor, for implementing a method. The method comprises receiving, by a first computer, transaction data for a transaction, determining, by the first computer, a first transaction score for the transaction, determining, by the first computer, that the first transaction score is indeterminate, storing the transaction data in a review queue, and providing, by the first computer, the transaction data to a second computer after a predetermined time has elapsed and the transaction data has not been reviewed. The second computer may be configured to query at least one data source external to the first computer for a supplemental data, and determine a second transaction score based on the transaction data and the supplemental data. The method also comprises receiving the second transaction score from the second computer, and determining an outcome for the transaction based on the second transaction score.

The first computer 220 may be in communication with and/or operatively coupled to a number of databases including a first fraud rule set database 222, a user database 224, and a transaction history database 226.

The first fraud rules database 222 may store fraud rules which can be applied to transactions conducted with a number of different merchants. The fraud rules may be stored individually or as merchant fraud rule profiles as explained above. The rules in the database 222 may include default rules set by the merchant processing system 130 or may include rules that have been customized or selected by the individual merchants. Exemplary fraud rules may include rules which take into account one or more of the following:

1. Product category information, such as a value that limits the maximum number of products in a particular category that a customer is permitted to purchase online in one transaction. Product categories may be specified by the transaction processing system, or specified by the merchant;

2. Selling frequency information, i.e., how often a customer is permitted to buy a particular product over a specified period of time, e.g., a subscription product that can be purchased only once a week;

3. One or more time of day weight values that indicate how important the buyer's time of purchase is, or that indicate what range of time in a day represents a reasonable time at which a buyer is expected to buy a particular product;

4. A “risky host” weight value that reflects an amount of risk associated with a particular host from which a customer order originates, as indicated by the customer's originating IP address or customer's claimed e-mail domain;

5. A gender bias value that indicates whether a specified product is strongly expected to be associated with a purchaser of a particular gender, so that risk increases if the system determines that the purchaser is probably of the other gender;

6. A value indicating the relative weight placed by the merchant on a difference in billing address and shipping address of the customer;

7. A first “velocity” value indicating how often the buyer has made online purchases at all; and

8. A second “velocity” value indicating how often the buyer has made online purchases of a specified product category from a specified merchant.

The user database 224 may store information about particular users. Such information may include payment account numbers (e.g., credit card numbers) or tokens (i.e., altered payment account numbers), user shipping addresses, user billing addresses, user security information such as user passwords, user preferences (e.g., purchase preferences).

The transaction history database 226 may store information about past transactions for different merchants and/or users. Transaction history information may include transaction data associated with individual transactions, supplemental data obtained for those past transactions, and the outcomes (e.g., whether a transaction is declined, approved, or reviewed) for those past transactions.

The second computer 240 may be in communication with a number of databases as well. Such databases may include a data source prioritization rules database 242 and a second fraud rules database 244.

In some embodiments of the invention, the second computer 240 may be configured to (i) query at least one data source external to the first computer for supplemental data, and (ii) determine a second transaction score based on the transaction data and the supplemental data. The second computer 240 may be configured to query various data sources in parallel or sequentially, and may do this through the data aggregator 170 or by itself. For example, if the data aggregator 170 is present, then appropriate data source query instructions may be provided to that data aggregator 170.

The data source prioritization rules database 242 may comprise rules for determining how data is retrieved by the previously described data aggregator 170. The rules may relate to the cost of obtaining the data from the different data sources, the speed of delivery of the data from the different data sources, the quality of the data from the different data sources, etc. The rules in the data source prioritization rules database 242 may have been previously created by or selected by the merchant or merchants using the system.

The second fraud rule set database 244 comprises a second of rules that can be applied to the transaction data, by the second fraud analysis module 240A, for a transaction to determine a second transaction score. Merchants may store second rule profiles or individual rules in this database. The rules in the second fraud rule set database 244 may contain rules that pertain to the supplemental data obtained from the various external data sources. For example, a rule in the second fraud rule set database 244 may produce a value if the user's e-mail address provided in the transaction data does not match an e-mail address provided by an external data source computer. This value may be a second transaction score or may be used to derive a second transaction score, which can be used to automatically determine an outcome for the transaction. The rule stored in the second fraud rules database 242 would be different from rules stored in the first fraud rules database 222, because it takes the supplemental data from external data sources into account before generating a transaction score.

The first computer 220 can receive the first fraud score and compare the first fraud score with a threshold range to determine whether the transaction is fraudulent. In an embodiment, the first fraud module 220A or first computer 220 may assess whether the first fraud score is fraudulent based on the fraud threshold range that represents an indeterminate transaction.

The fraud threshold range can be one number or a range of numbers based on the embodiment of the invention. In an embodiment where the threshold range is a set of numbers, the fraud threshold range might be 6 to 8. If the fraud score is from 1 to 5, then the transaction can be automatically accepted. On the other hand, if the fraud score is 9 or 10, then the fraud score might be unacceptable and the transaction may be automatically rejected. If, however, the fraud score is from 6-8, then the transaction is indeterminate. This means that the system was unable to definitively say whether the transaction is accepted or rejected.

In the instance where the fraud score is non-determinative (i.e. 6-8), meaning the system might not be able to determine that the transaction is fraudulent, the transaction data for the transaction is passed to the second computer 240. When the transaction data for the transaction is passed to the second computer 240, the second computer 240 may receive the transaction file, billing information, the first fraud score, and any other relevant information from the first computer 220. A second fraud score may be determined by the second computer 240 (or alternatively the first computer 220).

II. Methods

Prior to analyzing purchase transactions, a merchant may provide a number of fraud rules to the first and second fraud rules databases 222, 244, as well as the data source prioritization rules database 242. The fraud rules may be supplied to the first and second fraud rules databases 222, 244 by uploading files with rules or by selecting or modifying rules on a host site operated by the merchant processor system 130.

The rules in the data source prioritization rules database 242 can be supplied in a similar manner. The rules in the database 242 specify which data sources to request data from and what conditions. The rules regarding which data sources to contact may take into account the type of transaction currently being conducted, the transaction amount, the response time of the various data sources, the cost of accessing the specific data sources, etc. The rules allow the particular selection of data sources to be dynamic in nature.

Some merchants may want to use external data sources solely based on cost, while others may prefer a source because of the data format that they provide. An interface would allow the merchant to define what steps to take for the review (e.g., first source checks the phone number in public records, and then retrieves LexisNexis™ data if the public record data is insufficient to reach a conclusion as to whether to accept or reject the transaction). The system can also provide a “chain of callouts” so that it first receives TARGUSinfo data because it is less expensive, but if that data doesn't match what is on file, LexisNexis can be contacted for more expensive data.

In another example, the data sources that are accessed may depend upon the transaction amount. For example, if a transaction is $5, then an expensive data source is not accessed. However, if a transaction is over $3,000, then all available data sources could be contacted. The system may also estimate the cost for contacting one or more data sources to compare with a predetermined threshold.

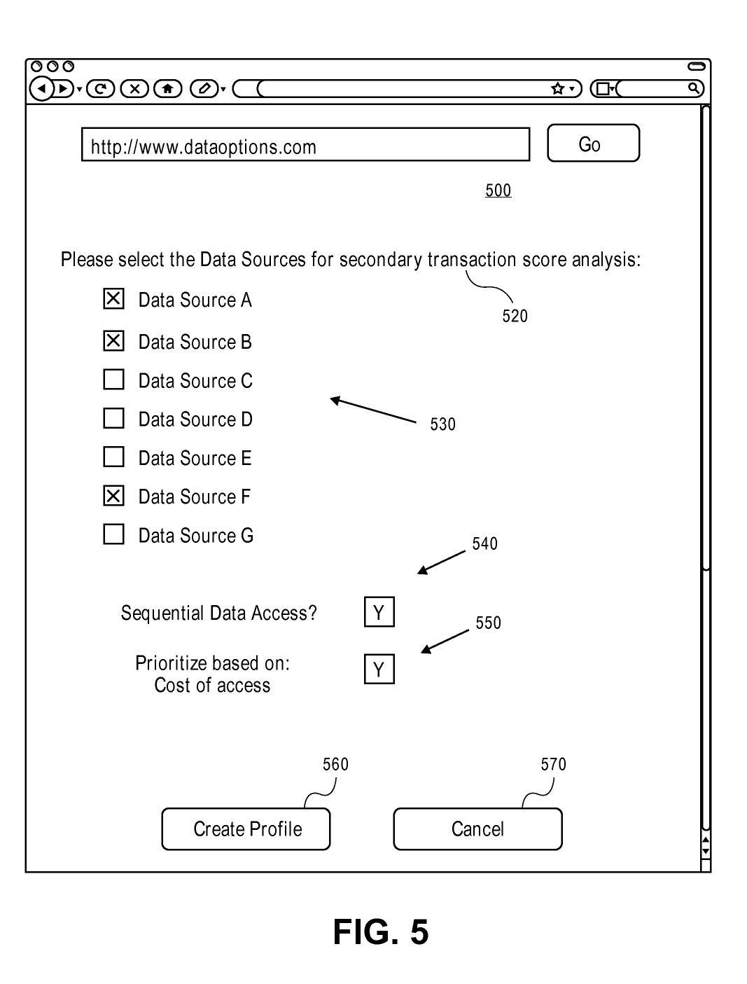

FIG. 5 shows a screenshot of a graphical user interface 500 that a merchant may use to provide specific rules to the data source prioritization rules database 242 and the second fraud rules database 244. The graphical user interface 500 may include a message 520 requesting a merchant to select one or more data sources to access. The data sources may be listed in a list of data sources 530 and the merchant may select one, some, or all of the data sources 530. The merchant may also indicate in boxes 540, 550, whether sequential data access is desired and whether prioritization is to occur by access cost, respectively. A “create profile” button 560 and a cancel button 570 are also illustrated. After the merchant selects the “create profile” button 560, the created profile can be stored in the data source prioritization rules database 242.

In some embodiments of the invention, a merchant may determine that a particular data source or set of data sources is particularly reliable for certain types of transactions or for all transactions. In this case, a merchant may simply select those data sources that are to be accessed during the second level review.

In embodiments of the invention, when a plurality of data sources are selected by a merchant to further analyze transaction data after an initial review, data from those data sources can be retrieved simultaneously or sequentially. For example, in some embodiments, once transaction data is reviewed by a second computer, the second computer may obtain first supplemental information from a first data source and may determine if the first supplemental information from the first data source is sufficient to determine if the transaction should be accepted or rejected. If it is not sufficient, then the second computer may query a second data source (e.g., via a data aggregator) to obtain second supplemental data. The second computer may then determine if the second supplemental data is sufficient to determine if the transaction should be accepted or rejected. If it is not sufficient, then a third data source, fourth data source, etc., may be queried in a similar manner.

For instance, in one example, a first data source may be less expensive, but may not have recent information about a user's phone number. The supplemental data that comes back to the second computer may include a user's address, but may not include a phone number. It may be that the user recently acquired a new phone and the phone number information may not have been obtained by the first data source. Because the phone number information is not present, the second computer could then decide to request supplemental data from a second data source which is more expensive, but which provides more up to date information. The supplemental data from the second data source may include the user's current phone number. Using this information, the second computer may determine that the phone number and the billing address that were provided by the user in making the purchase matches the supplemental data received from the first and second data sources. Consequently, the second computer may provide a transaction score that indicates that the transaction is likely to be authentic and may automatically accept the transaction for processing.

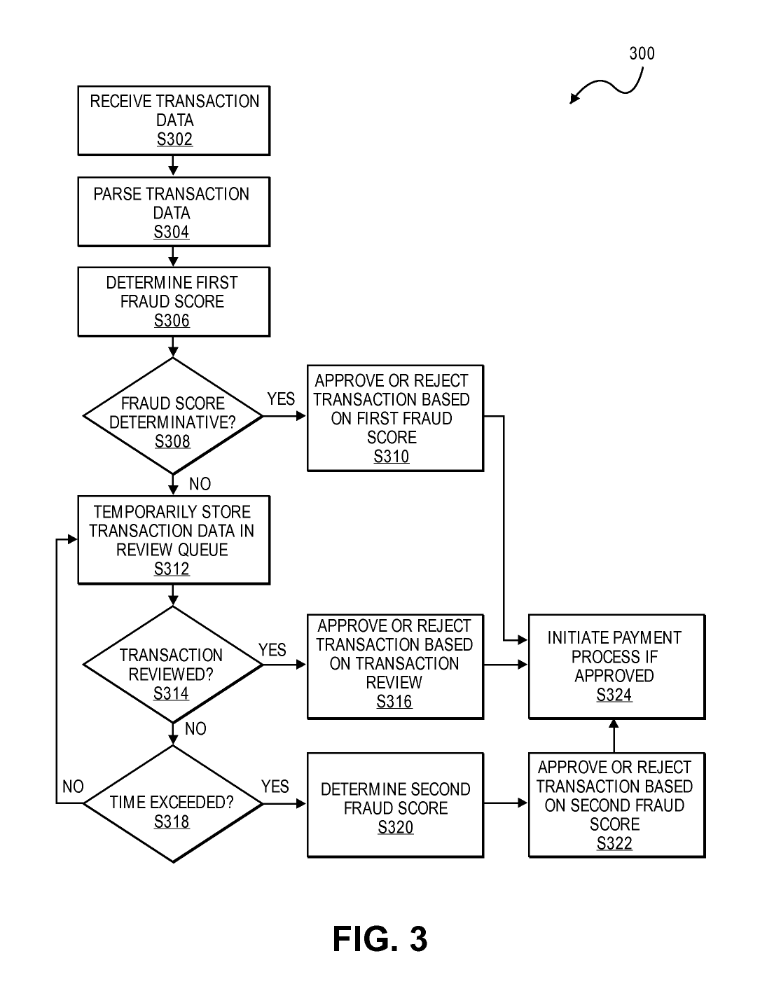

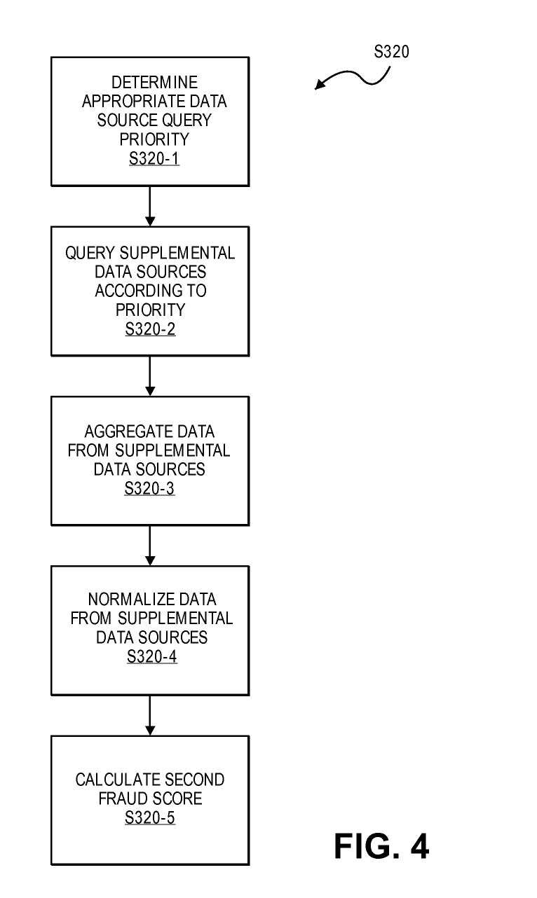

FIGS. 3-4 show flowcharts illustrating methods according to embodiments of the invention. The steps in the flowcharts can be described with reference to the systems illustrated in FIGS. 1-2.

In step S302, transaction data for a transaction is received by the first computer 220 in the merchant processing system 130 from the merchant computer 120. The transaction may be an e-commerce transaction for the purchase of goods and/or services (e.g., clothing). The transaction data may be generated after the user 100 contacts the merchant's Website 120A using the client computer 106. After the user's client computer 106 contacts the Website 120A, the user 100 may provide transaction data including a description of the item being purchased, the purchase amount (including taxes and shipping), and payment information including a payment account number, expiration date, and CVV2 value.

In step S304, the transaction data is parsed. The transaction data may be rearranged, reformatted, etc., so that the first computer can analyze the transaction data and create a transaction score.

In step S306, the first computer determines a first transaction score for the transaction. In an embodiment of the invention, the first computer 220 uses the first fraud analysis module 220A to conduct a first fraud analysis. The first fraud analysis module 220A may perform one or more of the following processes in the determination of the first transaction store: a history check, consistency check, address verification, IP-address identification verification, a velocity check, and/or other validity checks that indicate that the transaction is fraudulent.

The first fraud analysis module 220A may be configured to create a first fraud score to the transaction based on the output from some or all of these checks, and possibly other checks. The first fraud score can be a weighted combination of a variety of checks. For example, the first fraud module might determine the transaction history of a buyer is the most important information related to a particular buyer and assign it a heavier weight. When the first fraud module receives a new transaction, it may first review the individual buyer's billing information and determine if the buyer has a history of transactions. If the buyer has a history, the first fraud module may assign greater weight to the buyer's history, whether positive or negative, and use that weighted value to determine if the current transaction will most likely be fraudulent as well.

After the first fraud analysis module 220A assesses each of the checks, the first fraud module can generate a first fraud score for the transaction. In an embodiment, the first fraud score may be on a range of 1 to 10, where 1 identifies the transaction as a very low likelihood of being fraudulent and 10 identifies the transaction as a very high likelihood of being fraudulent.

In step S308, the first computer 220 determines if the first transaction score is indeterminate. For example, in the illustration above, the merchant may have determined that a fraud score in the range of 1-5 will have an “accept” status while a range of 9-10 will have a “reject” status. Thus, the transaction will be determinate if the first transaction score is 1-5 or 9-10. However, if the first transaction score is 6-8, then the first transaction score is indeterminate.

If the first transaction score is determinate, then in step S310, the transaction is accepted or rejected or rejected based upon the first fraud score. If the transaction is accepted, then in step S324, then a payment process is initiated. If the transaction is rejected, then a message may be sent to the merchant computer 120 indicating that the transaction is rejected. This indication may also be sent to the client computer 106 to inform the user 100.

In step S324, the payment process may be initiated in any suitable manner, depending upon the mode of payment. Payment may be made using any suitable payment mechanism including by credit card, by debit card, by ACH (automated clearing house), by electronic wallet, etc.

If the transaction is conducted using a credit or debit card account, then an authorization request message may be generated by the merchant processor system 130 and this message may be transmitted to the issuer computer 160 via the acquirer computer 140 and the payment processing network 150. The issuer computer 160 may analyze the authorization request message and may either approve or deny the transaction. The issuer computer 160 may then transmit an authorization response message back to the merchant processor system 130 and the merchant computer 120 via the acquirer computer 140 and the payment processing network 150. At the end of the day, a clearing and settlement process is performed between the acquirer computer 140 and the issuer computer 160. Further, the merchant may also ship the goods to the user 100 or may provide the service requested by the user 100.

In step S312, if the transaction is indeterminate, then the transaction data is temporarily stored in a review queue 260 along with the first transaction score determined by the first computer 220. The transaction data for the transaction will reside in this queue until a human reviewer can review the transaction data. The human reviewer may be an employee of the merchant and may review the transaction data and the first fraud score to decide whether to accept or reject the transaction.

In step S314, after a period of time after step S312, a determination is made as to whether or not the transaction has been reviewed by a human reviewer. Note that prior to the transaction, the merchant may specify the specific period of time to the merchant processor system 130.

In step S316, if the transaction data has been reviewed by a human reviewer, then the transaction is accepted or rejected based on the human reviewer's decision. As explained above, if the transaction is rejected, then a notification may be transmitted to the merchant computer 120 and subsequently to the client computer 106 to inform the user 100 that the transaction has been rejected. If the transaction is accepted, then in step S324, the payment process can be initiated as described above. Further, the merchant may also ship the goods to the user 100 or may provide the service requested by the user 100.

In step S318, if the transaction has not been reviewed and the time limit (e.g., ½ hour, one hour, two hours, etc.) for review has not been exceeded, then the transaction data remains stored in the review queue 260.

In step S320, if the time limit for review has been exceeded, a second fraud score is determined by the second computer 240. The first computer 220 may provide the transaction data and the first transaction score to the second computer 240 or the second computer 240 may retrieve this information directly from the review queue 260.

In step S320, the second fraud score is determined by the second computer 240. The second computer 240 is configured to (i) query at least one data source external to the first computer for a supplemental data, (ii) determine a second transaction score based on the transaction data and the supplemental data.

The process for generating the second fraud score, by the second computer 240 is illustrated in FIG. 4.

In step S320-1, the second computer 240 determines an appropriate data source query priority from the data source prioritization rules database 242.

In step S320-2, the second computer 240 queries the supplemental data sources. This can be performed by submitting a data request to the data aggregator 170. In other embodiments of the invention, the data aggregator 170 is not required and the second computer 240 may query the first, second, and third data sources 182, 184, 186, directly.

As noted above, the data sources 182, 184, 186 may be queried by the second computer 240 and/or the data aggregator 170 in parallel or in sequence. In some embodiments, the data sources 182, 184, 186 are queried in sequence. The order of querying the data sources 182, 184, 186 may be based on preferences of the merchant, cost of accessing data from the data sources 182, 184, 186, the amount of the transaction, the availability of the data sources, and/or the quality of the data from the data sources 182, 184, 186. Querying the data sources 182, 184, 186 sequentially has advantages, since the cost of obtaining data from all of the data sources 182, 184, 186 is not incurred if data from one of the sources is sufficient to allow the second computer 240 to make a decision to accept or reject the transaction.

In step S320-3, the data from the supplemental data sources is received and aggregated by the data aggregator 170 or directly by the second computer 240.

In step S320-4, the data from the supplemental data sources 182, 184, 186 is normalized. That is, similar data from the different data sources 182, 184, 186 may be provided in different formats, and such data may be converted to the same format so that it can be analyzed by the second computer 240.

In step s320-5, the second fraud score is calculated by the second computer 240. The second computer 240 may re-evaluate the transaction data based upon the supplemental data received from the external data sources, and may determine a second transaction score. For example, the first transaction score previously determined by the first computer may have been 7 on a scale of 1 to 10 where 1 indicates a very low likelihood of fraud and 10 indicates a high probability of fraud. The first computer 220 may have determined that a transaction having a transaction score in the range of 6-8 was indeterminate. However, the first data source 182 may be government database such as the DMV for the user's state and the supplemental data obtained from the DMV may indicate that the address in the DMV database does not match the billing or the shipping address provided by the user. Further, the second data source 184 may be a social network website and the supplemental data from this website may indicate that the listed user is currently on vacation, and would therefore be unlikely to conduct a transaction of this type while on vacation. With this additional information, the second computer 240 may create a second transaction score which is higher than the first transaction score since the supplemental data received by the second computer 240 provides additional evidence that the transaction may not be authentic. Thus, in this example, the second computer 240 may determine that the first transaction of 7 should be adjusted to a second transaction score of 8.

Referring again to FIG. 3, in step S322, the transaction can be accepted or rejected based upon the second fraud score. The second fraud score can be an example of an outcome for the transaction. In some embodiments of the invention, the transaction score generated by the second computer 240 may be accepted or rejected but may not be indeterminate so that a decision is made without human intervention. For example, the second computer 240 can accept the transaction if the transaction score is from 1-7, but reject the transaction if the score is from 8-10.

In step S324, the payment process can be initiated once the transaction has been approved. As explained above, if the transaction is rejected, then a notification may be transmitted to the merchant computer 120 and subsequently to the client computer 106 to inform the user 100 that the transaction has been rejected. If the transaction is accepted, then in step S324, the payment process can be initiated as described above. Further, the merchant may also ship the goods to the user 100 or may provide the service requested by the user 100.

Other embodiments are also possible. For example, although a second computer is illustrated, embodiments of the invention could also include a third (or fourth, fifth, etc.) computer. If the second computer cannot make a decision on the transaction with additional data, then a third computer applying different rules and using data from yet other data sources could be used.

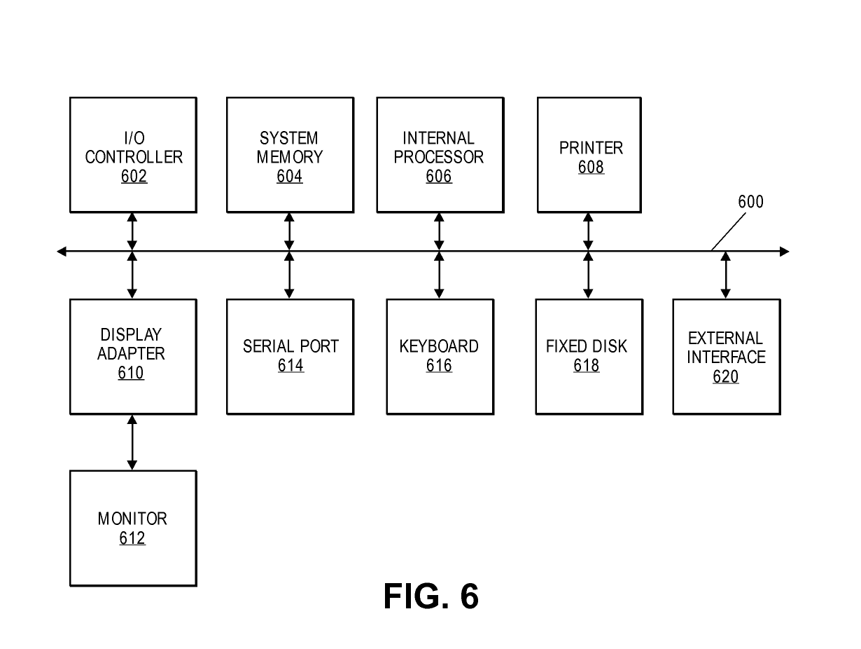

The various participants and elements may operate one or more computer apparatuses (e.g., a server computer) to facilitate the functions described herein. Any of the elements in the figures may use any suitable number of subsystems to facilitate the functions described herein. Examples of such subsystems or components are shown in FIG. 6. The subsystems shown in FIG. 6 are interconnected via a system bus 600. Additional subsystems such as a printer 608, keyboard 616, fixed disk 618 (or other memory comprising computer readable media), monitor 612, which is coupled to display adapter 610, and others are shown. Peripherals and input/output (I/O) devices, which couple to I/O controller 602, can be connected to the computer system by any number of means known in the art, such as serial port 614. For example, serial port 614 or external interface 620 can be used to connect the computer apparatus to a wide area network such as the Internet, a mouse input device, or a scanner. The interconnection via system bus 600 allows the processor 606 to communicate with each subsystem and to control the execution of instructions from system memory 604 or the fixed disk 618, as well as the exchange of information between subsystems. The system memory 604 and/or the fixed disk 618 may embody a computer readable medium.

Embodiments of the invention have a number of advantages. As noted above, embodiments of the invention can include the automated query of additional data sources to determine if a transaction should be accepted or rejected. The resulting decision on whether to accept or reject the transaction is more accurate since additional data is used to make the decision, and reduces the need for a human review, thereby resulting in technical efficiencies.

While the present invention has been described using a particular combination of hardware and software in the form of control logic and programming code and instructions, it should be recognized that other combinations of hardware and software are also within the scope of the present invention. The present invention may be implemented only in hardware, or only in software, or using combinations thereof.

The software components or functions described in this application may be implemented as software code to be executed by one or more processors using any suitable computer language such as, for example, Java, C++ or Perl using, for example, conventional or object-oriented techniques. The software code may be stored as a series of instructions, or commands on a computer-readable medium, such as a random access memory (RAM), a read-only memory (ROM), a magnetic medium such as a hard-drive or a floppy disk, or an optical medium such as a CD-ROM. Any such computer-readable medium may also reside on or within a single computational apparatus, and may be present on or within different computational apparatuses within a system or network.

The present invention can be implemented in the form of control logic in software or hardware or a combination of both. The control logic may be stored in an information storage medium as a plurality of instructions adapted to direct an information processing device to perform a set of steps disclosed in embodiments of the present invention. Based on the disclosure and teachings provided herein, a person of ordinary skill in the art will appreciate other ways and/or methods to implement the present invention.

One or more features from any embodiment may be combined with one or more features of any other embodiment without departing from the scope of the disclosure.

Any recitation of “a”, “an” or “the” is intended to mean “one or more” unless specifically indicated to the contrary.

The above description is illustrative and is not restrictive. Many variations of the invention will become apparent to those skilled in the art upon review of the disclosure. The scope of the invention should, therefore, be determined not with reference to the above description, but instead should be determined with reference to the pending claims along with their full scope or equivalents.

What is claimed is:

1. A system comprising:
a processor; and
a computer readable medium, the computer readable medium comprising code, executable by the processor, for implementing a method comprising
a) receiving, by a first computer, transaction data for a transaction,
b) determining, by the first computer, a first transaction score for the transaction,
c) determining, by the first computer, that the first transaction score is indeterminate,
d) storing the transaction data in a review queue,
e) providing, by the first computer, the transaction data to a second computer after a predetermined time has elapsed and the transaction data has not been reviewed,
f) determining a second transaction score; and
g) determining an outcome for the transaction using the second transaction score.

2. The system of claim 1 where the outcome is accepting the transaction or rejecting the transaction.

3. The system of claim 1 wherein the at least one data source comprises a social networking host site.

4. The system of claim 1 wherein the second computer is configured to (i) query a plurality of external data sources for supplemental data, and (ii) determine the second transaction score based on the transaction data, the supplemental data, and the first transaction score.

5. The system of claim 1 wherein the second computer is configured to (i) query a plurality of external data sources for plurality of supplemental data, (ii) prioritize accessing the external data sources according to one or more conditions, and (iii) determine the second transaction score based on the transaction data and the supplemental data.

6. The system of claim 5 wherein the second computer is configured to prioritize accessing the external data sources according to cost.

7. The system of claim 5 wherein the second computer is configured to prioritize accessing the external data sources according to the quality of the supplemental data from the data sources.

8. The system of claim 5 further comprising:
a data aggregator, wherein the data aggregator is configured to aggregate the supplemental data from the plurality of external data sources, and normalize the supplemental data from the plurality of external data sources.

9. The system of claim 1 wherein the method further comprises:
querying, by the second computer, at least one external data source for supplemental data; and
determining the second transaction score based on the transaction data and the supplemental data.

10. The system of claim 1 wherein the first transaction score is a first fraud score and the second transaction score is a second fraud score.

11. A method comprising:
a) receiving, by a first computer, transaction data for a transaction;
b) determining, by the first computer, a first transaction score for the transaction;
c) determining, by the first computer, that the first transaction score is indeterminate;
d) storing the transaction data in a review queue;
e) providing, by the first computer, the transaction data to a second computer after a predetermined time has elapsed and the transaction data has not been reviewed;
f) determining a second transaction score; and
g) determining an outcome for the transaction using the second transaction score.

12. The method of claim 11 wherein the outcome comprises accepting the transaction or rejecting the transaction.

13. The method of claim 11 wherein the at least one data source comprises a social networking host site.

14. The method of claim 11 wherein the second computer is configured to (i) query a plurality of external data sources for supplemental data, and (ii) determine the second transaction score based on the transaction data and the supplemental data.

15. The method of claim 11 wherein the second computer is configured to (i) query a plurality of external data sources for supplemental data, (ii) prioritize access to the external data sources in the plurality of external data sources according to one or more conditions, and (iii) determine the second transaction score based on the transaction data and the supplemental data.

16. The method of claim 15 further comprising:
accessing, by the second computer, the external data sources.

17. The method of claim 15 further comprising:
accessing, by the second computer, the external data sources according to the cost of accessing each of the external data sources.

18. The method of claim 15 further comprising:
aggregating the supplemental data from the plurality of external data sources, and normalizing the supplemental data.

19. The method of claim 11 further comprising:
querying, by the second computer, at least one external data source for supplemental data; and
determining the second transaction score based on the transaction data and the supplemental data.

20. The method of claim 11 wherein the first transaction score is a first fraud score and the second transaction score is a second fraud score.
